(19) United States
(12) Patent Application Publication
(10) Pub. No.: US 2016/0363806 A1
(43) Pub. Date: Dec. 15, 2016

(54) Carrying Case with Electrochromic Panels

(71) Applicant: Mohawk Innovations Limited, CITY CENTRE (IE)

(72) Inventors: Alexandra L. Sinderbrand, New York, NY (US); Maximus Yaney, New York, NY (US); Noah Fram-Schwartz, Greenwich, CT (US)

(73) Assignee: Mohawk Innovations Limited, CITY CENTRE (IE)

(21) Appl. No.: 15/244,632

(22) Filed: Aug. 23, 2016

(51) Int. Cl. G02F 1/1333; G02F 1/133; G02F 1/1335; A45C 5/03; A45C 3/02; A45C 3/00; A45C 15/06; A45C 3/06; G02F 1/1334; G02F 1/1347

(52) U.S. Cl. CPC G02F 1/133308; G02F 1/1334; G02F 1/13318; G02F 1/13342; G02F 1/1336; G02F 1/1347; A45C 3/02; A45C 3/001; A45C 15/06; A45C 3/06; A45C 5/03; G02F 2001/133342

(57) ABSTRACT

This invention relates to a carrying case with at least one electrochromic panel that can reversibly change from an opaque “off-state” to a highly transparent “on-state” when a button, dial, switch, snap, voice command, remote device, toggle, proximity sensor, other pocket, pouch, or flap on the carrying case, temperature sensor, or any other type of actuator that applies a charge to the electrochromic panel is activated. The electrochromic panel can be on any facet of the carrying case or multiple electrochromic panels can layer on top of each other to create various effects. Each electrochromic panel can have varying properties including, but not limited to, unique textures, transparency when voltages are applied, polarizations, colors, densities, finishes, and/or holographic displays. The electrochromic panel can be used on various appliances, furniture, devices, and/or over optical lenses to prevent an unauthorized remote user from viewing scenes through the optical lens.

### BACKGROUND OF THE INVENTION

Field of the Invention

This invention relates to the field of carrying cases. More specifically, the present invention relates to a carrying case with at least one panel that can reversibly change from an opaque “off-state” to a highly transparent “on-state,” when a user activates a button, switch, snap, voice command, remote device, dial, toggle, triggers a proximity sensor, opens another pocket, pouch, or flap on the carrying case, by a temperature sensor, timing device, or any other type of actuator. At least one electrochromic panel may be on any facet of the carrying case, such as but not limited to, the front, rear, side, top, bottom, and/or interior pockets, compartments, pouches, or flaps.

Additionally, there can be an illumination device that allows a user to better see the contents of the carrying case through the electrochromic panel. The illumination device can be activated prior to, concurrently with, or subsequent to the activation of the electrochromic panel.

A further aspect of the invention is to have a carrying case with at least one electrochromic panel wherein the electrochromic panel has a colored hue when in the opaque and/or transparent state. It is further designed that the electrochromic panel can have more than one color or change colors when in the opaque and/or transparent state. Alternatively, there can be multiple electrochromic panels layered on top of each other to create various effects.

This carrying case is designed so the user can have the option to control the color and color change speed of the electrochromic panel using a variety of mechanisms, including but not limited to, the polarity, charge, frequency, liquid crystal density, and polymer dyes. Another feature of the invention is for the electrochromic panel to have various textures, density, polarizations, holograms, and/or patterns.

Description of the Related Art

There are many types of carrying cases in the marketplace. However, none address the long felt need of allowing a user to see the contents of the carrying case without having either completely transparent panels or having to open the carrying case.

A carrying case with highly transparent panels risks allowing others to see the contents of the carrying case, which is undesirable, and can cause embarrassment, lead to theft, or harm photosensitive carrying case contents. Alternatively, opening up the carrying case risks the contents spilling out or being exposed to elements such as rain, snow, heat, and/or theft.

Additionally, there is a need to be able to see into a carrying case in a darkened environment to find or confirm that it contains certain contents. The addition of an electrochromic panel with an illumination device allows a user to easily see the contents of the carrying case without needlessly searching through the carrying case when in a darkened environment. In preferred embodiments, the illumination device is a light emitting diode (LED) of any shape, form factor, and/or color. In another preferred embodiment, the illumination device is an electroluminescent lamp.

A further aspect of the invention is to ease the search process in airport security or other security environments wherein a user must open a carrying case in a crowded public space for security inspection. This invention of an electrochromic panel enables a user to show the contents of the carrying case to security personnel without requiring the security personnel to open up the carrying case and potentially touch all the contents to inspect the interior. The ability to show the contents of the carrying case without opening it up also reduces the likelihood that the contents will become lost and/or stolen.

A further aspect of this invention is to provide a fun, stylish, and utilitarian accessory.

A further aspect of this invention is to provide security to a user when an electrochromic panel is used to cover an optical lens.

### SUMMARY OF THE INVENTION

The following is a non-limiting written description of embodiments illustrating various aspects of this invention. As used herein, the term carrying case means any portable container for enclosing something for safekeeping. The term carrying case is considered to encompass any type, style, dimension, and/or form factor of a baby bag, backpack, bag, billfold, box, clutch, computer bag, crate, diaper bag, duffel bag, garment bag, handbag, hatbox, hide, knapsack, make-up case, package, pocketbook, purse, roller bag, sack, satchel, shopping bag, shoulder bag, suitcase, toiletry bag, tote, trunk, or wallet.

The term electrochromic panel is considered to mean any device wherein two electrochromic cells are separated by an electrolytic layer. An electrochromic panel is considered synonymous with any electrochromic device (ECD) that can control the optical properties of the device, such as but not limited to, optical transmission, absorption, reflection, and/or emittance in a continuous but reversible manner when the voltage or polarity to the electrochromic cells are changed.

### DETAILED DESCRIPTION OF THE INVENTION

This invention relates to a carrying case that has at least one panel that may reversibly change from opaque to highly transparent upon activation by a user. In a preferred embodiment, the at least one electrochromic panel is made of a polymer dispersed liquid crystal (PDLC). In a preferred embodiment, the PDLC is designed so micro liquid crystalline droplets are dispersed in a polymer continuum.

PDLC films are opaque in the off-state when there is no applied voltage or charge to the film. In the off-state, when there is no charge applied, the liquid crystalline droplets are not aligned and not uniform. Therefore, light rays scatter on the various liquid crystalline droplets and the light scattering is not equivalent to the polymer's refractive index, so the PDLC film is opaque to a human viewer. When a charge is applied to the PDLC film, the liquid crystalline droplets within the polymer matrix aligns so the film becomes highly transparent and the refractive index of the polymer and refractive index of the liquid crystalline droplets are equivalent, and thus the film is transparent to a human. The degree of transparency depends on the thickness of the film, density, and number of liquid crystalline droplets dispersed in the polymer continuum.

The PDLC has at least two electric conductors on it. The at least two electrical conductors are connected to a power cable, which is connected to a power supply such as, but not limited to, a battery, photovoltaic cell, or DC power supply.

In a preferred embodiment, the power supply is a photovoltaic cell, such as a solar cell. In another embodiment, the power supply is a battery.

In another aspect of the preferred embodiment the at least two electrical conductors are made out of a metal such as, but not limited to copper, aluminum, or silver. The metal can be brazed, oxidized, and/or anodized. In embodiments where the power supply is a photovoltaic cell, a diode is connected to the photovoltaic cell to prevent current from flowing back into the photovoltaic cell. Additionally, an inverter is used to convert the DC power generated by the photovoltaic cell and/or battery to AC power for the purpose of applying a charge to the liquid crystalline droplets to change their state (or orientation) from on (transparent, aligned) to off (opaque, unaligned), and vice versa.

In another aspect of this invention, the carrying case can also have a locking mechanism connected to the electrochromic panel that prevents the panel from turning transparent without the user's permission. In a preferred embodiment, the locking mechanism is a fingerprint reader or other biometric sensor. In an alternative embodiment the locking mechanism can be a switch, toggle, snap, button, voice command, remote device, dial, timer, or other adjuster that will prevent the electrochromic panel from transforming to the transparent state if not activated by the user. The remote device can be, but is not limited to any type of smartphone or smart device application, computer program, Bluetooth, infrared light, and/or light emitted diode (LED).

In another aspect of this invention, the carrying case can have a proximity sensor that automatically causes the electrochromic panel to become transparent when a user or object is within a specified range.

In another aspect of this invention, the carrying case can have a temperature sensor that will cause the electrochromic panel to change from the opaque off-state to the highly transparent on-state.

The at least one electrochromic panel can have any hue, pantone, color and/or tint. In a preferred embodiment, the at least one electrochromic panel is clear and not tinted when in the transparent state. In embodiments where there are multiple panels on a carrying case each panel can be any color, pantone, hue, and or tint in either the opaque and/or transparent state.

Another feature of the present invention, is the carrying case with an electrochromic panel that has multiple electrical conductors. The multiple electrical conductors can change the polarity and/or voltage applied to the electrochromic panel at various points on the panel and at varying frequencies to make unique patterns, logos, names, and/or emblems on each electrochromic panel. The multiple electrical conductors can also permit a predesignated portion of each electrochromic panel to be in the transparent state while other portions are opaque depending on the location of the electrical conductors and/or vice versa.

Another feature of the present invention, is the carrying case with an electrochromic panel, wherein the electrochromic panel is a holographic polymer-dispersed liquid crystal (H-PDLC) or memory-type H-PDLC wherein the device is thermally erasable.

Another feature of this invention is the addition of an illuminating device such as a LED that allows a user to see into the carrying case when the electrochromic panel is in the transparent state. The illumination device can be in any color, shape, and/or form factor, and may be located inside or outside the carrying case on any facet and/or interior pocket, pouch, or flap. Additionally, the activation of the illumination device can be controlled by the same switch, toggle, button, or actuator that changes the electrochromic panel. Alternatively, the illumination device can be controlled by a separate activation device located elsewhere inside or on the exterior of the carrying case. In other preferred embodiments, there may be more than one illumination device.

The carrying case can be of any shape, style, fabric, material, color, dimension, and/or form factor. In addition, the at least one electrochromic panel can be of any shape, style, color when opaque, hue when transparent, dimension, and/or form factor.

In another aspect of this invention, there is a remote, switch, snap, button, adjustor, and/or actuator that can control at least one of the electrochromic panels' reversible activation from opaque to transparent. There can be multiple actuators for each electrochromic panel or one actuator for all of the electrochromic panels. Additionally there can be one actuator to control the transforming of the electrochromic panel from opaque to transparent or vice versa and another actuator to control the frequency of the change, illumination device, locking mechanism, and/or voice control.

It is designed such that the carrying case can have at least one electrochromic panel. Each electrochromic panel in the carrying case can have unique properties such as distinct colors, hue, and/or tints in the opaque and/or transparent state. In one embodiment, the electrochromic panel on the front facet of the carrying case can have a green hue when in the transparent state, while an electrochromic panel on the rear facet of the carrying case can have a red hue when in the transparent state.

Alternatively, the carrying case can have multiple electrochromic panels that are different shapes, sizes, dimensions, thicknesses, and/or form factors. Each panel can be a different size, a different thickness, have different functions, and/or different colors, hues, and/or tints in the opaque and/or transparent state.

In another aspect of this invention, the electrochromic panel can also have different textures, finishes, densities, and/or polarities. Additionally, the invention conceives of an electrochromic panel using various types of liquid crystals or nanocrystals.

In another aspect of this invention, there is a microphone in the carrying case or on the exterior of the carrying case. The microphone can control the electrochromic panels switching from transparent to opaque and vice versa, the frequency of the change of opacity, the at least one illumination devices and/or the locking mechanism preventing the electrochromic panel from becoming transparent at inopportune times or locations.

In another aspect of this invention, the interior of the carrying case and at least one electrochromic panel is waterproof and/or coated in a super hydrophobic coating to prevent foodstuffs, cosmetics, creams, and/or inks from damaging the carrying case. In another aspect of this invention, the at least one electrochromic panel may have an adhesive facet.

In another aspect of this invention, there is a remote device that can control the at least one electrochromic panels transformation from opaque to transparent and vice versa, the frequency of the transformation, locking mechanism, illumination device, and/or other features such as color, emblem, or logo display on the at least one electrochromic panel.

An additional aspect of this invention includes the ability to swap, replace, and/or add different electrochromic panel between carrying cases. Alternatively, a user can have a colored, tinted, patterned, and/or textured electrochromic panel and swap, replace, and/or add a different electrochromic panel to the carrying case.

In a further aspect of this invention, the at least one electrochromic panels can be using on any type of large, medium, or small appliance, carpentry or cabinet, and/or textile. It is conceived that an electrochromic panel with the features, colors, textures, and activations can be used on any type of device or appliance such as, but not limited to: an air conditioner, air ionizer, appliance plug, boiler, beverage opener, can opener, ceiling fan, clothes dryer, combo washer dryer, convection oven, dishwasher, fan, garbage disposal unit, grill, hairdryer, hair iron, heater, humidifier, HVAC system, icebox, iron, kettle, kimchi refrigerator, lamp, microwave oven, mirror, mousetrap, oil heater, oven, radiator, refrigerator, server, sewing machine, steamer, stove, sump pump, tie press, toaster, vacuum cleaner, washing machine, water cooker, window fan, or television. It is further conceived that the electrochromic panel can be used on closet or cabinet panels, furniture doors or drawers, clothing or textiles, glasses, camping equipment, camera lenses, tablets, and/or mobile phones.

In a further aspect of this invention, an electrochromic panel can be placed over a camera lens and/or optical device. When the electrochromic panel is in the “off-state,” and there is no applied voltage to the electrochromic cells, the panel is clearly opaque and not able to record a clear image. When the electrochromic panel is in the “on-state,” and there is an applied voltage to the electrochromic cells, the panel is clearly transparent and able to record a clear image. This allows a user to see when a camera and/or optical device is able to record without relying on a switch or algorithm that could be remotely controlled from an undesired user.

### BRIEF DESCRIPTION OF THE DRAWINGS

FIGS. 1A and 1B show user viewing a carrying case with an electrochromic panel in the opaque “off-state,” and highly transparent “on-state” state.

FIGS. 2A and 2B show user viewing a refrigerator with an electrochromic panel in the opaque and subsequently transparent state with a proximity sensor to control the electrochromic panel.

FIGS. 3A and 3B show a front and bottom perspective view of a carrying case with multiple electrochromic panels.

FIG. 4 shows a perspective view of a carrying case with multiple electrochromic panels.

FIG. 5 shows a perspective view of a carrying case with an electrochromic panel, locking mechanism, power supply, and reserve power supply.

FIG. 6 shows a perspective view of a carrying case with an electrochromic panel, power supply, reserve power supply, and proximity sensor.

FIG. 7 shows a front view of a kitchen with multiple appliances and accessories having electrochromic panels.

FIG. 8 shows a perspective view of a tent with an electrochromic panel.

FIG. 9 shows a perspective view of a mirror with an electrochromic panel.

FIG. 10 shows a perspective view of a security camera with an electrochromic panel.

### DETAILED DESCRIPTION OF THE EMBODIMENTS

This invention is designed such that a carrying case can have interchangeable electrochromic panels of various colors, hues, densities, sizes, orientations, and/or surface finishes. There are varying configurations for where and how the interchangeable electrochromic panels can affix to the carrying case.

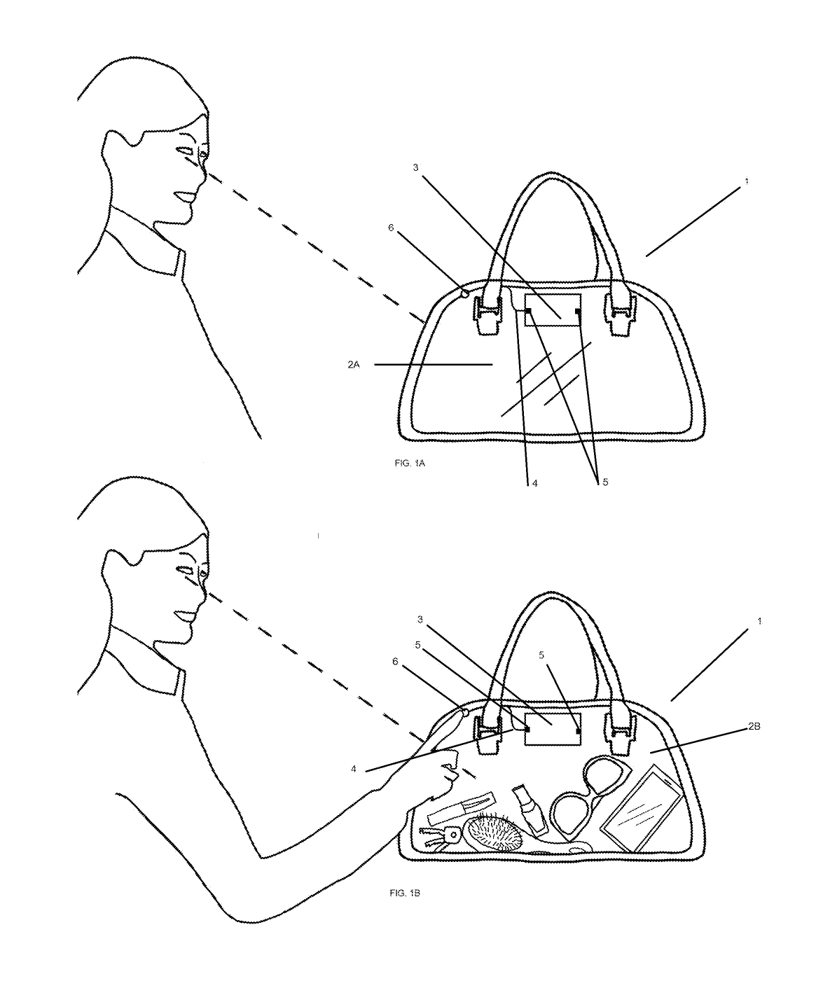

Referring to FIGS. 1A and 1B, a carrying case 1 has an electrochromic panel 2A in the opaque position so that others cannot see into the carrying case 1. The carrying case 1 has at least one electrical connector 5 connected to a power cable 4 which is connected to a power supply 3. When an actuator 6 is activated the electrochromic panel becomes transparent 2B and the user can see into and the contents of the carrying case 1.

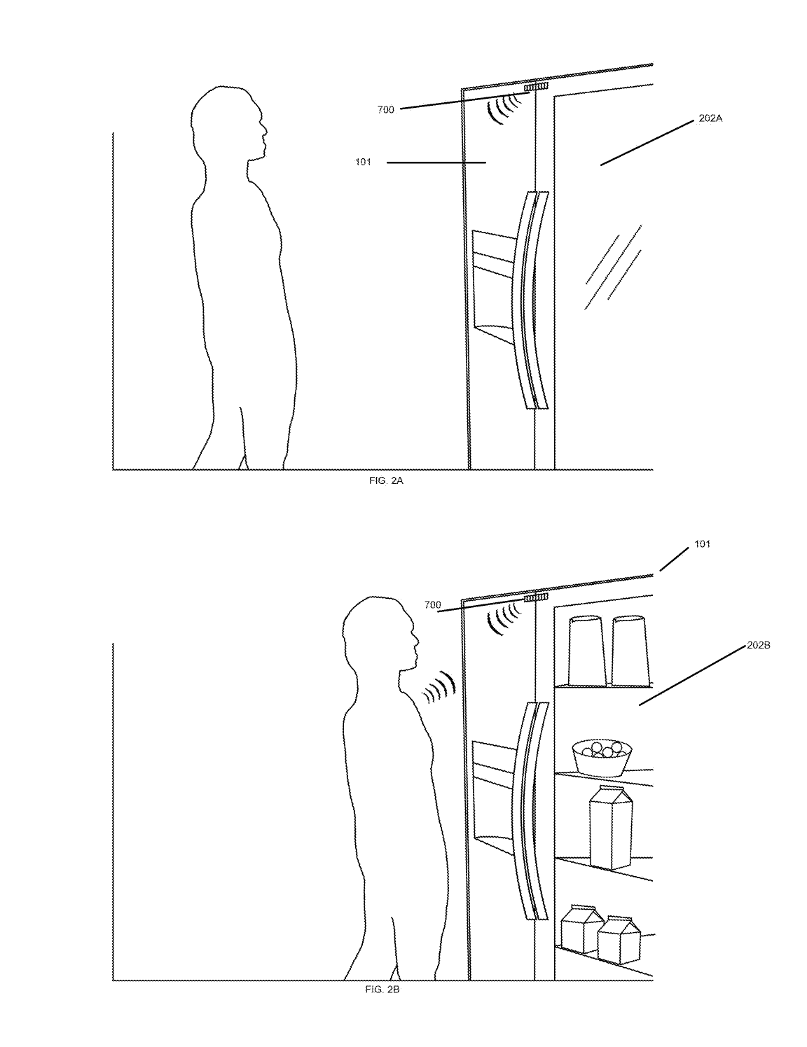

Referring to FIGS. 2A and 2B, an appliance 101 has an electrochromic panel in the opaque state 202A. When a user approaches the appliance 101, a proximity sensor 700 turns the electrochromic panel to the transparent state 202B so that the user can see the contents of the appliance 101 without opening it up and risking the contents being exposed to the elements.

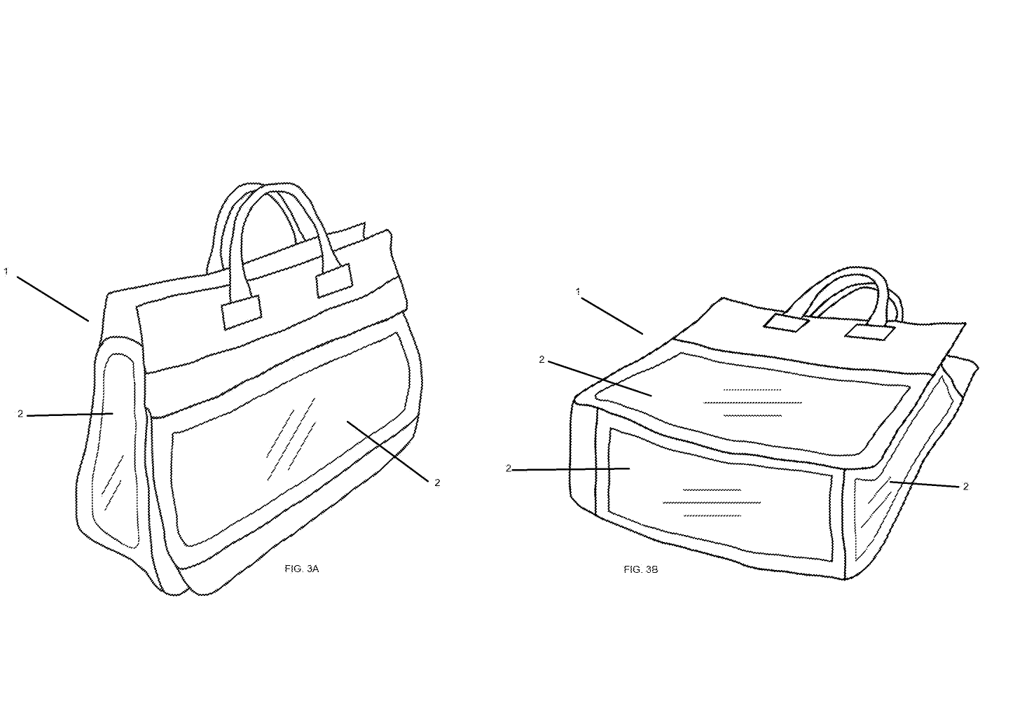

Referring to FIGS. 3A and 3B, a carrying case 1 with multiple electrochromic panels 2 on each facet of the carrying case 1. The user has the option of changing the opacity of each individual electrochromic panel 2 or of changing the opacity of all the electrochromic panels 2 in unison.

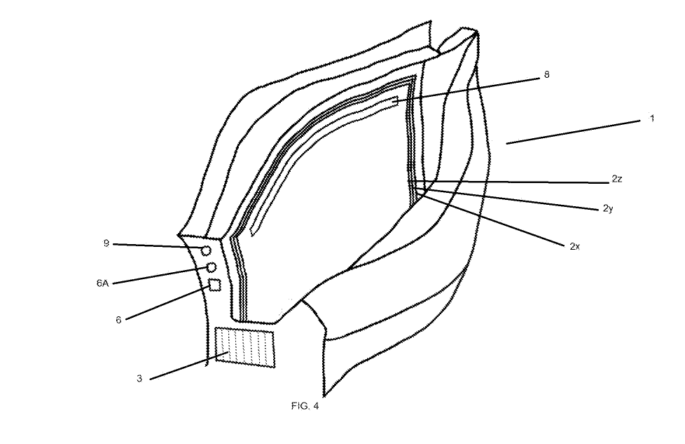

Referring to FIG. 4, a carrying case 1 can have multiple electrochromic panels 2x, 2y, and 2z layered primarily on top of each other to create various effects and transparency levels when one panel is in the off-state and another is in the on-state. Additionally, each electrochromic panel 2x, 2y, and 2z can be actuated individually by an actuator 6A, which can control the voltage, polarity, and frequency of the voltage applied to each electrochromic panel 2x, 2y, and 2z. Electrochromic panels 2x, 2y, and 2z may each have unique and different properties from each other, including, but not limited to unique and different textures, densities, temperature sensitivities, colors, holograms, electrical contact points, types of electrochromic materials, and/or liquid crystal droplets. There is a primary actuator 6 that can activate the power supply 3 to apply a charge to all of the electrochromic panels 2x, 2y, and 2z to change their respective states from transparent to opaque, and vice versa, an illumination device 8, and a locking mechanism 9, such as a fingerprint reader, that may prevent activation the electrochromic panels 2x, 2y, and 2z to the transparent state (on-state). There can be a back-up battery (not shown), microphone (not shown) and/or proximity sensor (not shown) to control when and how charge is applied to the electrochromic panels 2x, 2y, and 2z.

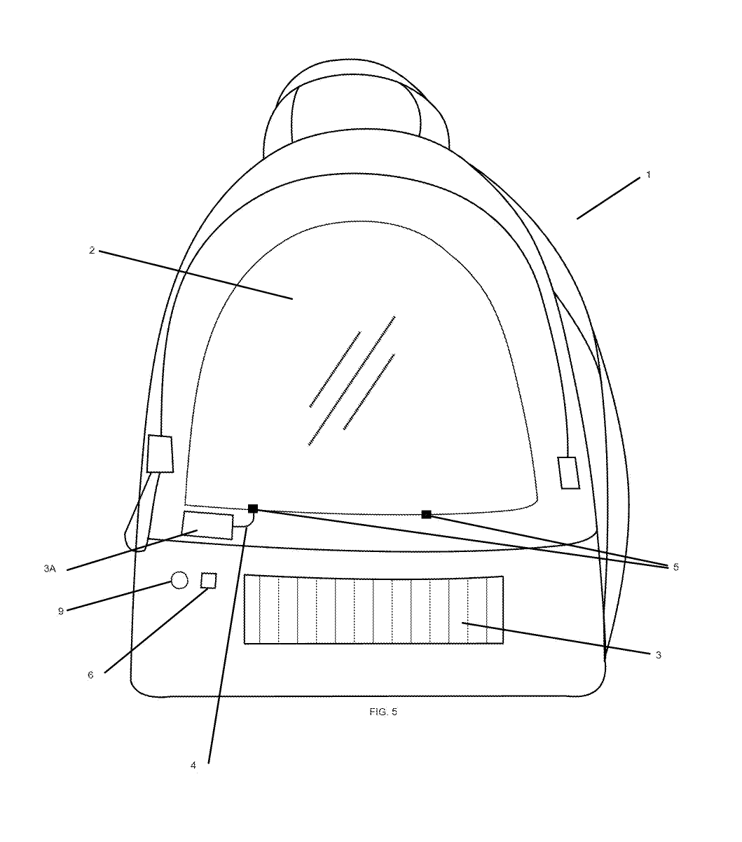

Referring to FIG. 5, a carrying case 1 has an electrochromic panel 2, a power supply 3, an actuator 6 that applies voltage to the electrochromic panel 2 when activated, a reserve power supply 3A, connected to at least two electrical connectors 5 by a cable 4, and a locking mechanism 9 to prevent the electrochromic panel from turning transparent. In a preferred embodiment the power supply 3 is a photovoltaic cell that has an additional diode to prevent current from flowing back into the photovoltaic cell and an inverter to convert the DC power from the photovoltaic cell to AC power to apply to the electrochromic panel 2 (diode and inverter not shown). The at least two electrical connectors 5 that can apply a charge to the electrochromic panel 2 from the power source 3 and/or reserve power supply 3A to change the optical properties and state of the electrochromic panel 2 from on to off and vice versa.

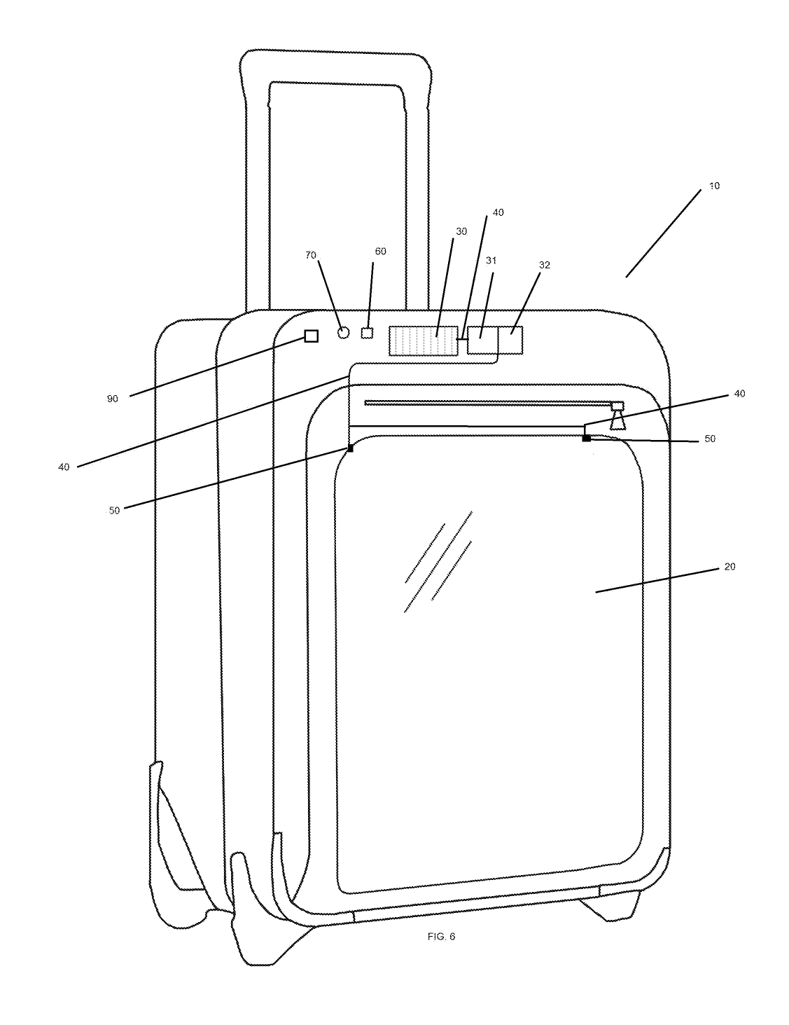

Referring to FIG. 6, a carrying case 10, has an electrochromic panel 20, power supply 30 that is a photovoltaic cell, diode 31, inverter 32, recharging battery 33, power cable 40, electrical connectors 50, actuator 60, and proximity sensor 70. In a preferred embodiment, when the actuator 60 is pressed or switched, a charge is applied to the electrochromic panel 20 can transform from the opaque to transparent state, and vice versa. There can also be a locking mechanism 90, such as a fingerprint reader or other biometric sensor, controlled by an actuator (not shown). This locking mechanism 90 can be controlled by the carrying case 10 user to prevent the electrochromic panel 20 from entering the “on-state” (highly transparent) at undesired times or locations.

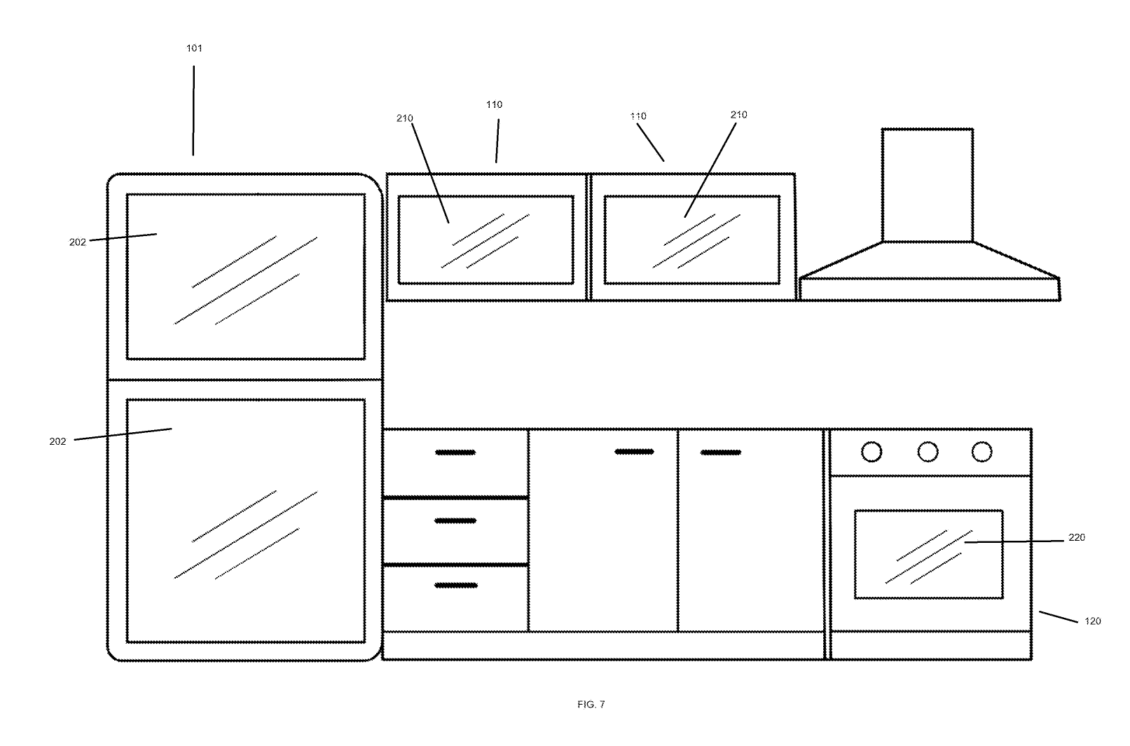

Referring to FIG. 7, an appliance 101 such a refrigerator can have an electrochromic panel 202 on a facet to allow a user to see the contents of the appliance 101 without opening a door. Another feature of this invention is a piece of furniture 110 such as a cabinet, having an electrochromic panel 210 to allow a user to see the contents of the cabinet 110 without opening the door. Another feature of this invention is an appliance 120 such as an oven, having an electrochromic panel 220 to allow a user to see the contents of the appliance 120 when the electrochromic panel 220 is in the transparent on-state without opening the oven door.

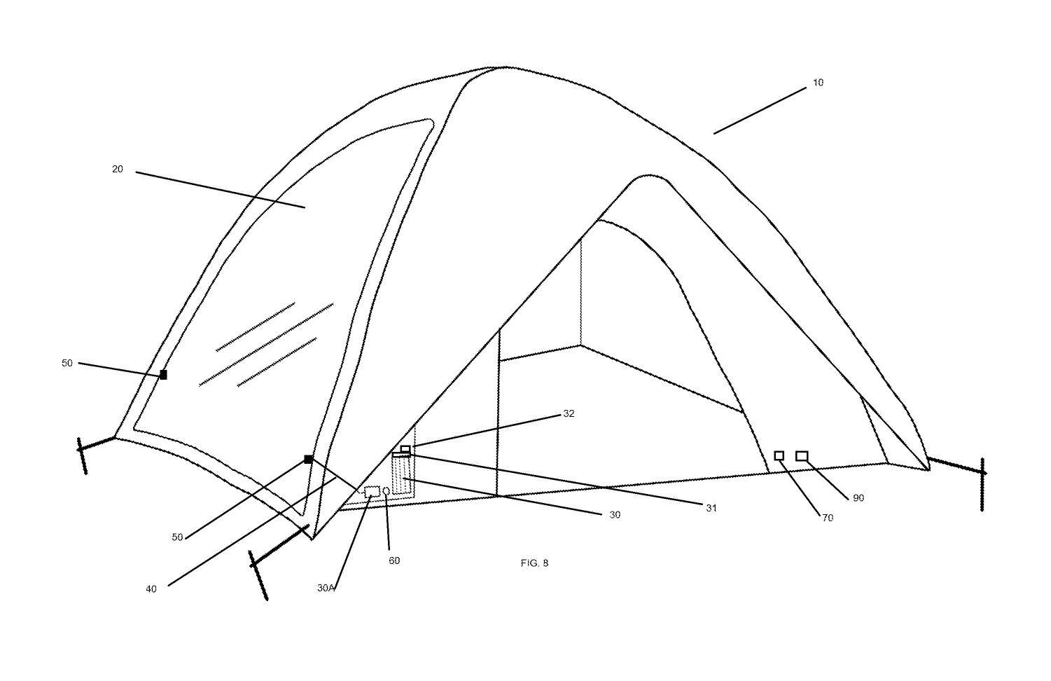

Referring to FIG. 8, a textile 10, such as a tent can have an electrochromic panel 20, a power supply 30, a diode 31, an inverter 32, a back-up battery 30A, a power cable 40, at least two electrical connectors 50, and an actuator 60. When the actuator 60 is pressed or otherwise turned, the power supply 30 can supply a current to the electrochromic panel 20 to cause it to become transparent. In a preferred embodiment, the power supply 30 is a photovoltaic cell that is connected to a diode 31 to prevent current from flowing back into the power supply 30, and an inverter 32 to convert the power supply 30 power from DC to AC current.

Additionally, there can be a proximity sensor 70 to control the opacity of the electrochromic panel 20, and a locking mechanism 90, to prevent the electrochromic panel 20 from entering the on-state (highly transparent) when the user desires the electrochromic panel 20 to remain in the off-state (opaque).

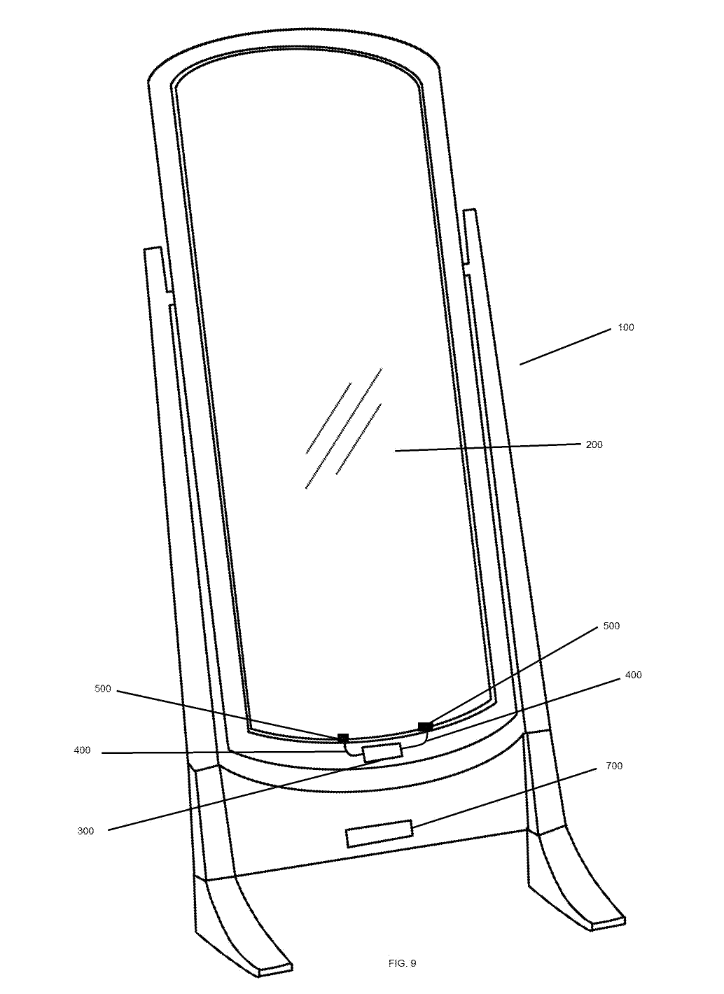

Referring to FIG. 9, an appliance such a mirror 100 has at least one electrochromic panel 200. A charge is applied to the electrochromic panel 200 via at least two electrical connectors 500, which are connected to a power source 300 via a power cable 400. There is a proximity sensor 700 to activate the electrochromic panel 200 and have it enter the “on-state” or highly transparent when a user is within a certain distance of the mirror 100. The mirror 100 then enters the “off-state” or opaque when a user is not near the mirror 100 and does not trigger the proximity sensor 700.

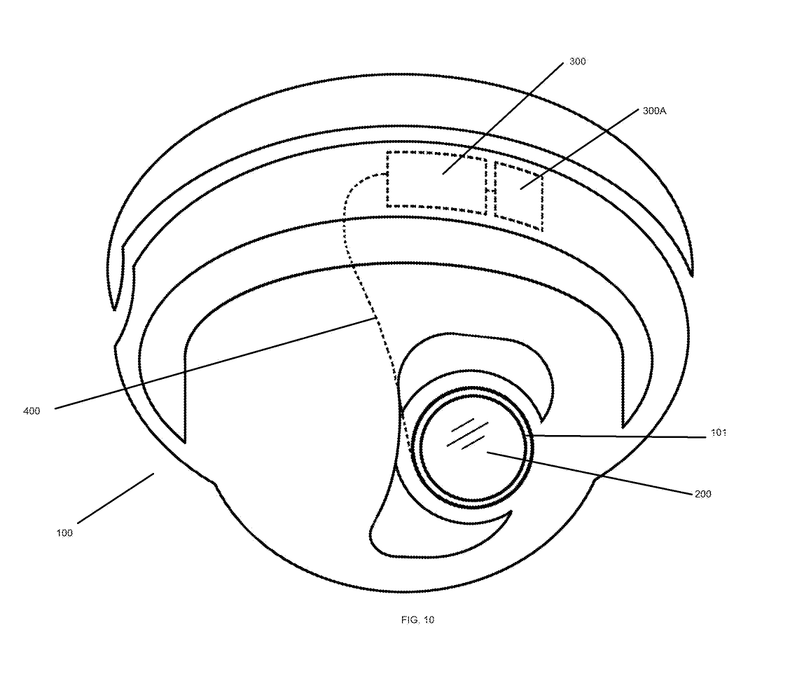

Referring to FIG. 10, an appliance such as a security camera 100 has an electrochromic panel 200 over a camera lens 101 so a user can have visual feedback as to when the camera 100 could theoretically see the user and/or the user's space. The electrochromic panel 200 is opaque when in the off-state (no voltage applied to the electrochromic panel 200) and highly transparent when in the on-state (voltage applied to the electrochromic panel 200).

Voltage is applied to the electrochromic panel 200 by electrical connectors (not shown) connected to a power cable 400, power source 300, such as a battery or photovoltaic cell, and a reserve power source 300A.

Although only a few embodiments of the present invention have been described herein, it should be understand that the present invention might be embodied in many other specific forms without departing from the spirit or scope of the invention. Therefore, the present examples and embodiments are to be considered as illustrative and not restrictive, and the invention may be modified.

What is claimed:

1. A carrying case comprising a first electrochromic panel on a first facet of the carrying case that can reversible change from an opaque state to a transparent state when a charge is applied to the first electrochromic panel.

2. The carrying case according to claim 1, wherein the first electrochromic panel is a polymer dispersed liquid crystal film.

3. The carrying case according to claim 1, wherein the voltage source to the first electrochromic panel is at least one photovoltaic cell portably attached to the carrying case, wherein the at least one photovoltaic cell is connected to a diode to prevent current from flowing back into the photovoltaic cell, and an inverter to convert DC power to AC power.

4. The carrying case according to claim 3, wherein the at least one photovoltaic cell is connected to a reserve battery.

5. The carrying case according to claim 1, wherein the first electrochromic panel has a visible texture, shape, form factor, matte, color, or hue.

6. The carrying case according to claim 1, wherein the first electrochromic panel is an H-PDLC.

7. The carrying case according to claim 1, wherein the first electrochromic panel can be reversibly removed from the carrying case and a second electrochromic panel can be inserted into a location where the first electrochromic panel was located.

8. The carrying case according to claim 1 comprising at least one illumination device that can be activated remotely by a user or by an actuator on the carrying case.

9. The carrying case according to claim 8, wherein the at least one illumination device is a light emitting diode (LED).

10. The carrying case according to claim 8, wherein the at least one illumination device is an electroluminescent lamp.

11. The carrying case according to claim 1, wherein there are multiple electrochromic panels layered on top of each other.

12. The carrying case according to claim 1, wherein there is a second electrochromic panel on a second facet of the carrying case.

13. The carrying case according to claim 11, wherein there is a third electrochromic panel on a third facet of the carrying case.

14. The carrying case according to claim 1, wherein multiple electrochromic panels can be on the first facet of the carrying case.

15. The carrying case according to claim 1, wherein multiple electrochromic panels can be on any facet of the carrying case.

16. The carrying case according to claim 1, wherein the first electrochromic panel is flexible.

17. The carrying case according to claim 1, wherein the voltage source to the first electrochromic panel is a battery.

18. An optical device comprising a first electrochromic panel covering the optical lens that can reversible change from an opaque state to a transparent state when a charge is applied to the first electrochromic panel.

19. The optical device according to claim 18, wherein the voltage source is a battery.

20. The optical device according to claim 18, wherein the voltage source is a photovoltaic cell.
